(19) United States
(12) Patent Application Publication
(10) Pub. No.: US 2006/0041663 A1
(43) Pub. Date: Feb. 23, 2006

(54) LOCATION BASED DYNAMIC INFORMATION SERVICES

(75) Inventors: David BROWN, Boulder, CO (US); David G. COHEN, Boulder, CO (US); Robert DURKIN JR., Boulder, CO (US)

Correspondence Address: HOGAN & HARTSON LLP, ONE TABOR CENTER, SUITE 1500, 1200 SEVENTEENTH ST, DENVER, CO, 80202, US

(73) Assignee: ICENTRIC CORPORATION, Boulder, CO (US)

(21) Appl. No.: 11/161,598

(22) Filed: Aug. 9, 2005

Related U.S. Application Data
(60) Provisional application No. 60/522,145, filed on Aug. 20, 2004.

(51) Int. Cl. G06F 17/30; G06F 15/16

(52) U.S. Cl. 709/226; 709/200; 707/3

(57) ABSTRACT

Systems, methods and software that provide information to a user based upon a combination of both geographic location to the user requesting the information and a determination that the information is provided by a person that is in some way similar to the user. In other words, information is organized such that information about the author of the information is associated with the information. For example, information such as demographics, geographic background, gender, age, as well as less common types of information about the author such as hobbies, interests, memberships and the like are associated with the information. When a specific user desires to access that information, the information is presented such that information from authors who are similar in some relevant way to the specific user is preferred over information from authors who are not similar to the specific user.

### DESCRIPTION

The present application claims the benefit of U.S. Provisional Patent application Ser. No. 60/522,145 entitled LOCATION BASEED DYNAMIC INFORMATION SERVICES filed on Aug. 20, 2005.

The present invention relates, in general, to information management services, and, more particularly, to software, systems and methods for managing, organizing, retrieving, and presenting information such that information about the author of the information is associated with the information.

### RELEVANT BACKGROUND

Computer users can look up far more information than can be used. Historically, access to broad-scope information sources is what was useful (think of an encyclopedia), nowadays access to valuable information is far more useful. One cannot just surf around until you stumble on what you're looking for; you need help finding it.

This is why data mining applications like search engines have become a critical part of everyday life. Even finding information, though, isn't enough. The most popular search engines are ones that display popular results, thereby filtering out the thousands of results that are not interesting.

Within a matter of years, the global positioning system (GPS) and the other location technologies will be increasingly available on a variety of consumer electronic devices such as cell phones, personal digital assistants, handheld computers and the like. A large number of such devices are already on the market. As a result, consumers will be able to use geographic location information in their electronic commerce (e-commerce) and mobile commerce (m-commerce) activities ways that have not yet been explored.

Currently, information retrieval systems such as search engines rank information that is presented to a user according to various criteria. In some cases the rankings are paid for by businesses and so do not attempt to reflect how valuable that information is to a requesting user. In other cases, the information may be ranked according to a popularity metric that indirectly reflects how valuable that information is to the population at large.

Another information retrieval tool is implemented as opinion web sites where comments and opinions from the population at large are posted. Because anyone with Internet access can post opinions to such sites, the opinions expressed therein may or may not be relevant to a particular individual who desires to review the information.

In addition to commerce and information retrieval, the Internet has become a tool for social interaction. Electronic mail (email), instant messaging (IM), and the like provide new modes of communicating and interacting with people. These modes of interaction increase the numbers of people that one can interact with by orders of magnitude. As a result, needs exist for systems and software that assist people in locating and communicating with friends and family amongst the large number of people at a particular location and time. Further, there are needs for systems that assist users in locating and meeting new people who have common interests and/or characteristics that suggest a mutually beneficial social interaction.

### SUMMARY OF THE INVENTION

Briefly stated, the present invention involves systems, methods and software that provide information to a user that is not only popular, but popular to other people that are in some way similar to the user. In other words, information is organized such that information about the author of the information is associated with the information. For example, information such as demographics, geographic background, gender, age, as well as less common types of information about the author such as hobbies, interests, memberships and the like are associated with the information. When a specific user desires to access that information, the information is presented such that information from authors who are similar in some relevant way to the specific user is preferred over information from authors who are not similar to the specific user.

In addition, it is contemplated that this information can be used in combination with global positioning system (GPS) or other geographic location information to help business and leisure travelers find restaurants, concerts and other events or locations in close proximity to their current location rated highly by other people like them, using an interface that is easy-to-use and intuitive. Other location information includes manually entered location information, location information derived from maps, location information that is associated with a telephone number, network node address, or similar sources of location information GPS or other user location information allows the information that is presented to be more relevant to the specific user requesting the information. It would also provide them with guidance to get there from their current location.

In another aspect, the present invention allows users to define a profile describing themselves and social preferences, create and maintain lists or directories such as “buddy lists”, lists of favorite places and lists of events. A device such as a GPS enabled phone is used to transmit a current location to the system in accordance with the present invention. Alternatively, other location information can be used or a user can manually input location information using the phone's keypad or a website. The system displays on the phone, web page, or other display a graphical representation of your location and the location of friends and favorite places and events relative to the user's current location. Preferably, the user has full control over who can receive the user's location information or other information from the user's profile.

### BRIEF DESCRIPTION OF THE DRAWINGS

FIG. 1 shows a distributed computing environment in which the present invention is implemented;

FIG. 2 illustrates a conceptual data record in a particular implementation of the present invention;

FIG. 3 illustrates exemplary data exchanges between entities in an embodiment of the present invention; and

FIG. 4 shows a conceptual block diagram of operation in accordance with the present invention.

### DETAILED DESCRIPTION OF THE PREFERRED EMBODIMENTS

A system in accordance with the present invention comprises a delivery system for the information, a software application that includes a set of learning algorithms that create a profile for each user and identifies other users that are similar to them. Information that is submitted by users such as ratings, opinions, directions, or virtually any other type of information is stored in a manner such that the user who submitted the information and that user's profile remain associated with the information itself.

The present invention allows a variety of functions that combine the use of a personal profile including prioritized data items that represent personal preferences of the owner of the profile. Examples of data items include people, places, musical preferences, food preferences, activity preferences and the like. The profile is used in combination with information about a location and time to plan and organize an event. In the case of a spontaneous event, the users' current time and location are used in combination with the users' profile-specified preferences to plan the event. In the case of a future event, a specified location and future time are combined with the users' profile-specified preferences to plan the event.

In a specific implementation, actions that can be performed by a user include:
Choosing a place and time and sending invitations to friends or groups of friends and then monitoring who has responded as well as how they have responded.
View a fried or place on a map and get directions to that location
Set “buddy alerts” to notify the user when a friend is nearby or has moved.
Rate locations in a manner that allows other users to view your rating.
Find nearby locations of interests, rated highly by people with a similar profile.
Search network of friends or the entire database of users.
Receive real time alerts when people you want to meet or people with similar interests are nearby.
Join up, communicate, and meet with groups of people with similar interests.
Facilitate introductions between users.

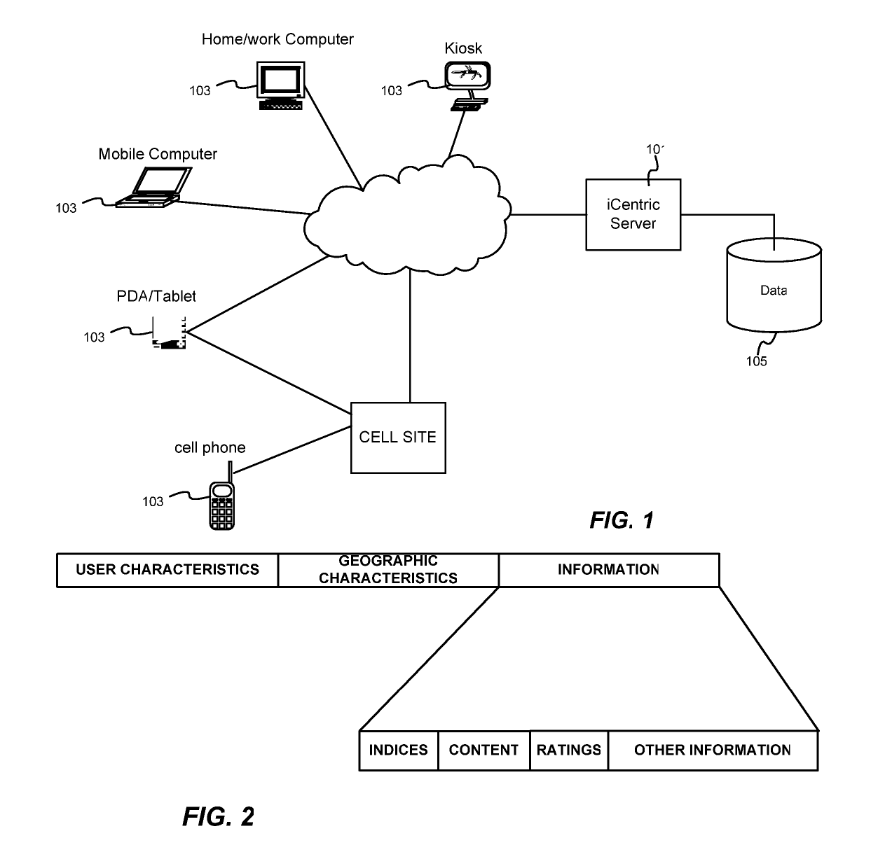

In a simple form, the present invention may be implemented, for example, as a web site accessed by web browser software at home or work using fixed-location desktop/laptop computers or distributed kiosks as suggested by devices 103 in FIG. 1. More commonly, however, it is expected that users will access the service in accordance with the present invention using highly mobile devices such as hand-held device (e.g., a cell phone, a PDA, a Blackberry or a new device), equipped with global positioning system (GPS) capability or other location information capability that provides location information (e.g., latitude and longitude) and makes the location information available to software implemented on the device. It is contemplated that the delivery system might be built into a cell phone, many of which have location based information and/or GPS available. The system enables the information to be delivered to multiple types of hardware, although human interfaces will likely differ based on the capabilities of the individual devices.

The location information is preferably specified with a reasonably fine granularity. For example, location information of a few city blocks accuracy might be acceptable for some applications, however, it is preferred that the location information be specified with an accuracy of 100 feet and more preferably 25 feet.

In operation, users interact through various devices 103 and using conventional network protocols such as TCP/IP, conduct request/response communication with server 101. In some embodiments a user turns on their access device 103 and activates a program that contacts server 101 to announce the user's location. The access device 103 can update location information periodically, occasionally, or in response to specific user input. In this manner, server 101 can maintain information about each user's location. Distribution of that location information, however, is controlled by the user's profile which contains a list of people and/or business entities that can access that location information.

When a user desires information a request is sent to server 101 that includes an identification of the requesting user as well as search criteria (e.g., words, terms, or other specification of the information that is desired). In certain embodiments the request also includes location information (e.g., latitude and longitude or a geocode of some form). Server 101 responds to user requests by querying datastore 105. Significantly, the query is not based only on the user-specified search criteria, but may also be based upon the user's profile which is retrieved using the provided user identification. The query may also be modified to account for the location information provided by the user's request. 2

Alternatively or in addition the user profile information can be used when formatting the search results for presentation to a user. For example, the order, arrangement, selection, highlighting, coloring or other formatting characteristics of a response can be chosen to emphasize information that is particularly relevant to the requesting user. Specifically, in the case of information provided by another user (e.g., a restaurant or store recommendation), that information is considered more relevant to the requesting user when a user that provided that information has a profile that is similar in some way to the profile of the requesting user. In the case of more generic information that is not associated with another user, information is considered more relevant when that information matches data in the user's profile (e.g., information about Mexican restaurants will be considered more relevant if the user's profile indicates a preference for Mexican cuisine. Also, information may be considered more relevant when the content of the information and/or the source of the information is/are geographically relevant to the location information provided in the request (e.g., a nearby store is more relevant than a store several blocks away).

A software application is implemented on server 101 that, in a particular embodiment, includes a set of learning algorithms that profile each user. This profiling can be explicit using survey techniques, or can be implied by interpreting the type and content of user communications. The software application identifies users that are similar to each other as indicated by matching characteristics in the users' profiles. When responding to information requests, the algorithms determine recommendations based on what these other users like.

The software application further comprises processes that enable a user to add his or her opinions to the database as well as processes that allow a user to search and retrieve information. The information can be written by the site owner, gleaned from other Web sites or other sources, or contributed by users. These allow users to provide commentary and opinion information on particular topics, for example product reviews.

A user base of many subscribers that allow the system to be intelligent. The more diverse personalities, the more ratings of individual locations, the smarter the system will get.

FIG. 2 illustrates a conceptual data record in a particular implementation of the present invention. Although FIG. 2 suggests a particular structure for the records, the actual physical and logical data structure would vary to meet the needs of a particular application. One intent is to illustrate that user characteristics and/or geographic characteristics are associated with the information so that it can be used when the information is retrieved and presented to a user.

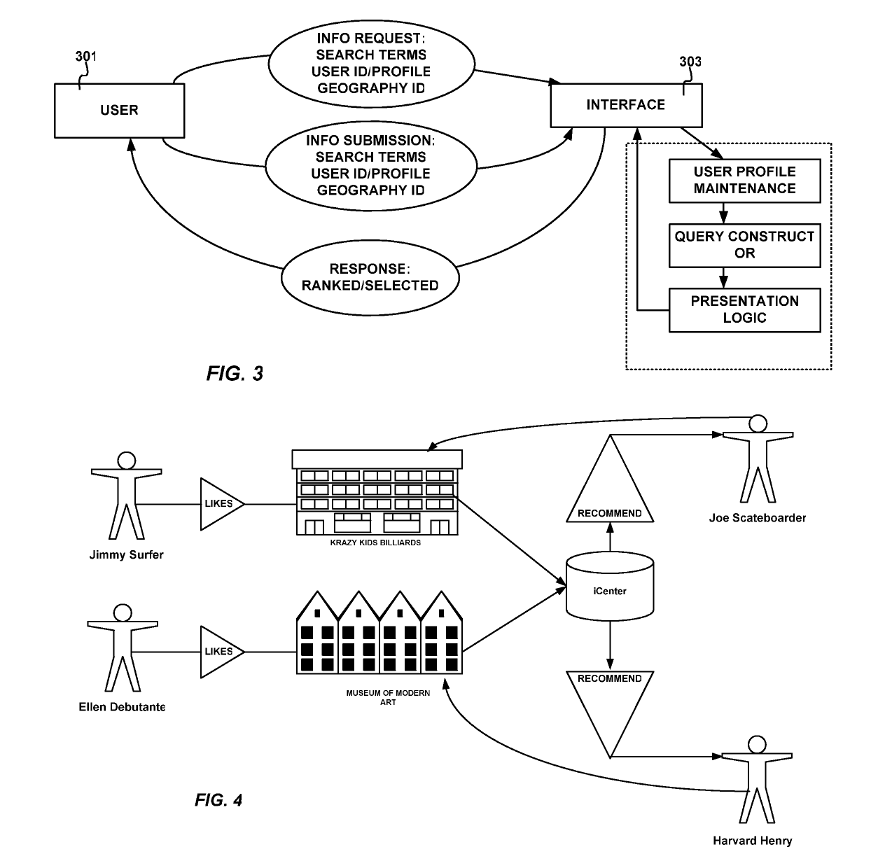

FIG. 3 illustrates exemplary data exchanges between entities in an embodiment of the present invention. Users 301 present information requests and information submissions to a system interface 303. System interface 303 may be implemented as a web page on server 101, for example, in which case information requests and submissions take the form of one or more packets of information using a standard protocol such as hypertext transfer protocol (HTTP). Interface 303 accesses other services on server 101 to perform, for example, user profile maintenance, data store query operations, and presentation of information to users. In a particular example, request/response traffic with a particular user is analyzed to update that user's profile. Information such as what types of information are being requested as well as what information is provided to the user can be monitored using linguistic analysis techniques, for example, to create and maintain a user profile. Linguistic analysis refers generally to processes that automatically or semi-automatically extract meaning from textual data. Using such techniques information about a user's characteristics can be implied from the communication by interpreting a textual statement such as “I had a great time at the museum” rather than relying exclusively on information gathered through questionnaires, surveys and explicit rankings provided by individuals.

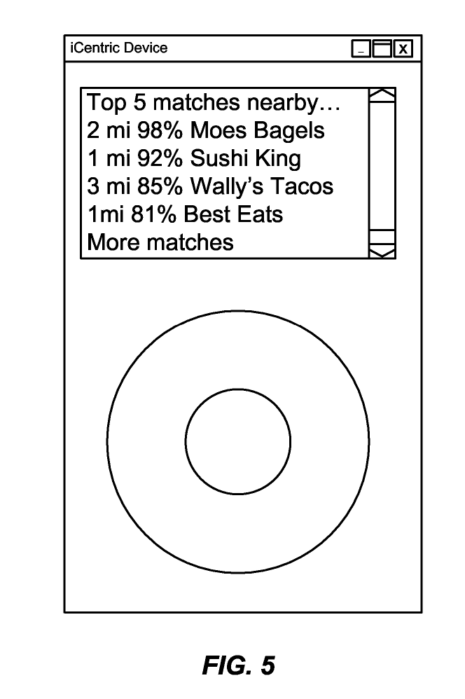

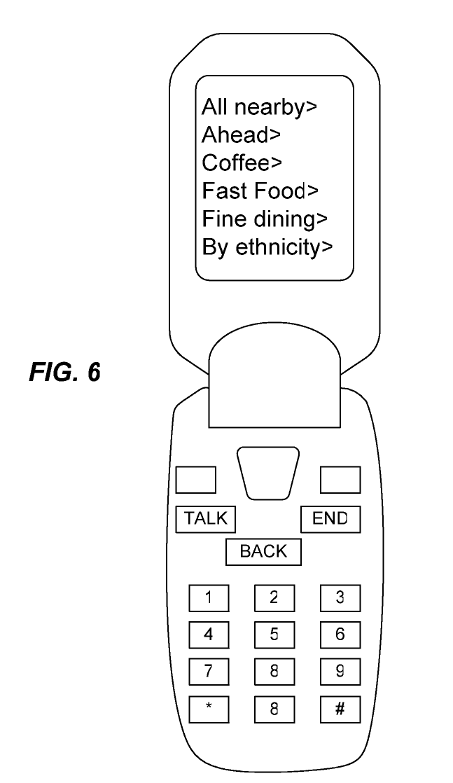

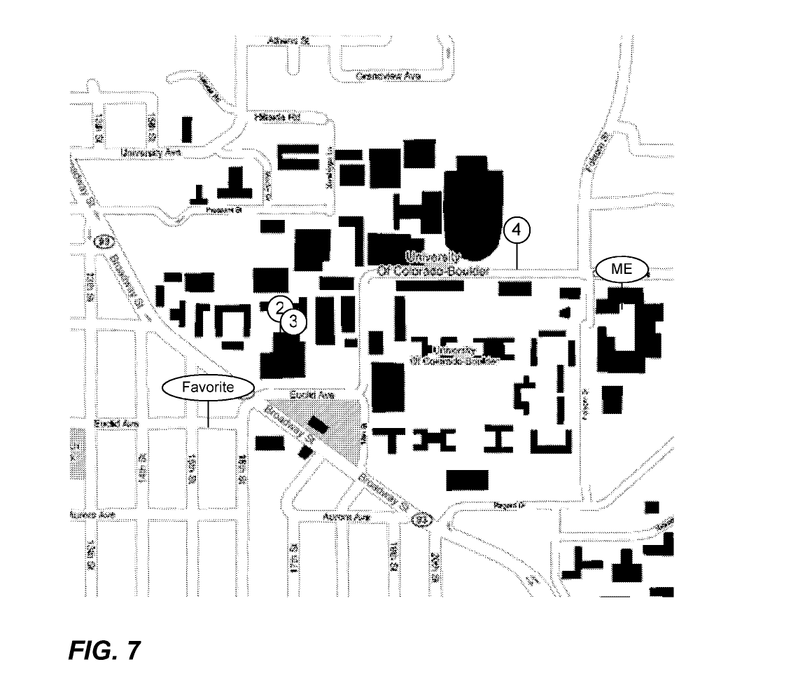

FIG. 4 shows a conceptual block diagram of operation in accordance with the present invention. From past ratings and personal preferences, we know that Joe and Jimmy have similar preferences in entertainment. Jimmy has, along with others, indicated that he has had positive experiences with Krazy Kids Billiards. This opinion is recorded in the central database, along with Jimmy's profile. Separately, Ellen has made similar positive comments about the positive experience with the Modern Art museum. Perhaps Ellen has even left negative comments about Krazy Kids.

When Joe makes a request for information about entertainment in his location, most prior directory services or even opinion-based services will provide information that was provided by both Jimmy and Ellen. In accordance with the present invention, however, Joe's profile matches Jimmy's (i.e., has a sufficient level of similarity to Jimmy's) and so information provided by Jimmy is considered more relevant to servicing Joe's request. In some implementations the system may exclude Ellen's opinions altogether, while in other implementations Ellen's information can be presented with relevant information so that Joe can weigh for himself how to balance Jimmy's and Ellen's information.

Similarly, when Henry makes a request for information about entertainment in the same locale, the system will identify the similarity between Ellen and Henry's profiles and provide Henry an entirely different response than Joe. Henry's response will include information from Ellen, and people like Henry and Ellen, as more relevant that information from people like Joe and Jimmy. In this manner, information that is valuable to decision making is preferentially provided to the requesting user.

Processes for ordering and presenting that information to a user are also contemplated. FIG. 5 and FIG. 6 show exemplary interfaces which are implemented on a handheld device such as a cell phone, PDA or other wireless handheld computing device. It is contemplated that the device includes some form of location technology such as GPS or similar system providing geographic coordinates from a cellular telephone infrastructure. Alternatively, a user can provide geographic coordinates to the system explicitly or by entering an address or phone number that is then translated to geographic coordinates. In FIG. 5 a user has indicated a basic query looking for restaurants information. The query is handled by the system in accordance with the present invention by looking for restaurants that are both highly rated by users with profiles similar to the requesting users and that are geographically close to the user. In FIG. 5 the items are ranked according to ratings of similar users and a numerical score, expressed in percentage, is provided to indicate strength of the recommendations and/or how similar the users who supplied the recommendation are to the user making the request.

FIG. 6 illustrates another user interface screen that allows results to be filtered by various user-selected criteria. For example, rather than all restaurants, a user can specify a type of establishment such as coffee, fast food, fine dining, etc. Because the present invention combines the use of opinion data with geographic location information, it is possible to filter and order requests not only according to geographic proximity, but also according to locations that are in a direction that the user is already heading (e.g., the “Ahead” control in FIG. 6). In this manner the present invention accounts not only for the instantaneous location of the user, but also expected location of the user over time or direction that the user is heading. This can be very beneficial when driving, for example, to minimize turning around needlessly.

FIG. 7 illustrates an exemplary graphical representation of information about people, places and events useful in practice of the present invention. In FIG. 7 a map is presented of locations proximate to a particular user's location or to a location specified by a user (e.g., a location that a user is expecting to be at in the future). The map is sized for presentation on a mobile display device 103 such as a cell phone display screen in a particular implementation. The user's location is identified by a marker such as the pushpin labeled “ME” in FIG. 7. FIG. 7 also presents location information for several friends labeled “2, 3 and 4” as well as a favorite location labeled “favorite”.

The user can, for example, invite friends 2, 3 and/or 4 to meet at the favorite location either now or at some specified time in the future. The user can simply send messages to the nearby friends, or the user can ask the system to create an alert or notification if any new friends come into proximity or any of friends 2, 3 or 4 leave the area.

If the user is not familiar with the area he or she can look for new locations that might be of interest based on ratings provided by other users (not shown). Alternatively, a user can look for new people (i.e., previously unknown people) in proximity and attempt to contact them to ask for recommendations). Such functionality would be useful in a variety of circumstances such as when a bicyclist is in an unfamiliar town but is looking for a recommended bike shop. The bicyclist can use the system of the present invention to find local bicyclists, for example, and ask them for recommendations of a nearby shop. At the same time, the visiting bicyclist may wish to join a ride with the local bicyclists, or invite the local bicyclist to join him or her.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A method for encouraging social interaction using a communication network comprising:
storing a plurality of profiles, wherein each profile includes data items that describe characteristics and preferences of a particular user;
dynamically associating location information with each of the plurality of profiles; and
establishing communication between users based on information in the profiles and location information associated with the profiles.

2. The method of claim 1 wherein a particular profile includes data items that describe a favorite business specified by the owner of the particular profile and location information for that business.

3. The method of claim 1 wherein the act of dynamically associating location information comprises providing global positioning system information from a user's cell phone to a system managing the plurality of profiles.

4. The method of claim 1 further comprising the act of displaying a graphical representation of a region proximate to a particular user together with indications of selected other users within the displayed region.

5. The method of claim 4 wherein the selected other users are selected based upon information in the profile of the particular user.

6. The method of claim 1 further comprising the act of displaying a graphical representation of a region proximate to a particular user together with indications of locations of one or more selected places within the displayed region.

7. The method of claim 6 wherein the selected places are selected based upon information in the profile of the particular user.

8. The method of claim 1 further comprising causing the particular user to initiate a query for a particular type of information; and
responding to the query by providing information that satisfies the query and is consistent with one or more data items in the particular user's profile.

9. A system for managing information comprising:
a network-connected server implementing software for storing and retrieving data from a data store in response to user requests;
a profile data store having a profile describing personal characteristics of each user; and
processes for retrieving information from the data store based upon a criteria specified by a user;
processes for presenting the retrieved information to the requesting user, wherein the content and/or manner in which the information is presented is based at least in part upon a user profile of a user associated with the information being retrieved.

10. The system of claim 9 wherein the request further comprises information about the user's location and the processes for retrieving and presenting information are based at least in part on the location information.

11. The system of claim 9 wherein the processes for retrieving information use the requesting user's profile information to select information from the data store.

12. The system of claim 9 wherein the user accesses the network-connected server using a portable computing device such as a PDA or Blackberry.

13. The system of claim 10 wherein the information about a user's location is provided automatically by an interface device employed by the user to make the request.

14. The system of claim 9 wherein the network connected server implements learning algorithms that profile each user based upon requests and responses of the user.

15. The system of claim 9 wherein the network connected server implements matching algorithms to identify users with similar profiles when retrieving and presenting information.

16. A method for providing information to users of a system, the method comprising the steps of:
providing a profile for each user, the profile having information describing personal characteristics of the user;
receiving information requests specifying criteria from a user;
retrieving information that satisfies the user-specified criteria from a data source;
presenting the retrieved information to the requesting user, wherein the content and/or manner in which the information is presented is based at least in part upon a user profile of a user associated with the information being retrieved.

17. A mobile communication device comprising:
processes within the mobile communication device for informing a central information system of the location of the mobile communication device;
processes for receiving information from the central information system, wherein the received information includes information about people and/or places proximate to the location of the mobile communication device that satisfy preselected criteria; and
a user interface for displaying the received information.

18. The mobile communication device of claim 17 wherein the device is a cell phone.
